(19) United States
(12) Patent Application Publication
(10) Pub. No.: US 2015/0316411 A1
(43) Pub. Date: Nov. 5, 2015

(54) Method and System for Intrinsic LED Heating for Measurement

(71) Applicant: KLA-TENCOR CORPORATION, Milpitas, CA (US)

(72) Inventors: Mark McCord, Los Gatos, CA (US); Yu Guan, Pleasanton, CA (US); James George, Berkeley, CA (US)

(21) Appl. No.: 14/699,880

(22) Filed: Apr. 29, 2015

Related U.S. Application Data
(60) Provisional application No. 61/988,087, filed on May 2, 2014.
(60) Provisional application No. 62/065,749, filed on Oct. 19, 2014.

(51) Int. Cl. G01J 1/18; G01J 1/04; G01J 3/02; H05B 33/08

(52) U.S. Cl. CPC G01J 1/18; H05B 33/0815; H05B 33/089; G01J 1/0403; G01J 3/0251; G01J 3/0286; G01J 2001/1673

(57) ABSTRACT

The present disclosure provides methods and apparatus for testing light-emitting diodes (LEDs), for example, measuring the optical radiation of an LED. In a method, a pulse-width modulated signal is provided to the LED. One or more characteristics of the PWM signal are varied so as to provide a forward voltage, V_{f}, corresponding to a target junction temperature, Tⱼ, of the LED. The optical radiation of the LED is measured when the LED obtains the target junction temperature.

### CROSS-REFERENCE TO RELATED APPLICATIONS

This application claims priority to U.S. Provisional Application No. 61/988,087, filed on May 2, 2014, now pending, and U.S. Provisional Application No. 62/065,749, filed on Oct. 19, 2014, now pending, the disclosures of which are incorporated herein by reference.

### STATEMENT REGARDING FEDERALLY-SPONSORED RESEARCH OR DEVELOPMENT

This invention was made with government support under DE-EE0005877 awarded by the U.S. Department of Energy. The government has certain rights in the invention.

### FIELD OF THE DISCLOSURE

The disclosure relates to LED photometric testing, and more particularly to the use of calibration standards in such testing.

### BACKGROUND OF THE DISCLOSURE

In-line testing of light-emitting diodes (LEDs), particularly white high-brightness LEDs used for general illumination, is generally performed with an integrating sphere and a photospectrometer. Accurate measurement of color coordinates and total light output requires calibration and periodic recalibrations traceable to an absolute standard certified by NIST or another national lab. Depending on the construction of the test apparatus (tester), initial and periodic calibrations may be required for each different type and package of LED (which can number into the dozens or even hundreds of different configurations).

Current calibration techniques involve a cumbersome two-step process where a “golden” set of devices are calibrated in a laboratory tester against a NIST standard. These devices are then run through a factory tester as “transfer standards.” Calibration offsets are calculated and programmed into the factory tester. The calibration must be done periodically (typically monthly, but may be otherwise) and is also performed when the tester is reconfigured to run a different device or package.

It typically takes a couple of hours to complete a calibration, resulting in significant loss of tester availability. The transfer standards are typically “home-made” and do not fit the testers well. In addition, the transfer standards usually do not stay with the testers because typically only one or two sets of such transfer standards are made and shared among all testers in a company. The multiple steps (including the frequent moves of the standards among testers) add measurement uncertainties and introduce more opportunity for human or mechanical errors. Temperature variations can also be a source of additional error.

In a light-emitting diode, a junction between p-type and n-type semiconductor forms the diode. The accuracy of an LED calibration standard is only guaranteed when the junction temperature, Tⱼ, is held at its specified value. This is typically accomplished with a temperature regulator, which may be a heater/cooler comprising, for example, a resistive or thermoelectric device, a large heat sink, a fan, and an electronic controller. The temperature regulator causes the calibration standard to be significantly larger than the LED alone (see FIG. 1). On most production testing tools, however, the location for the standard allows only about enough space for an LED itself.

Controlling the temperature of an LED calibration standard using a temperature regulator is also slow and inefficient because the diode junction being controlled is heated or cooled from outside the diode. In addition, the combined cost of the added temperature regulating device, the electronics for controlling it, and the heat sink can be approximately 100 times the cost of the LED alone.

### BRIEF SUMMARY OF THE DISCLOSURE

The present disclosure provides a method for measuring optical radiation from a light-emitting diode (LED). The method comprises providing a pulse-width modulated (PWM) signal to the LED. The PWM signal has current pulses with a duty factor, a pulse width, an amplitude, and a frequency. One or more of the duty factor, the pulse width, the amplitude, and/or the frequency of the current pulses are adjusted to provide a forward voltage, V_{f}, corresponding to a target junction temperature, Tⱼ, of the LED. The method comprises measuring, when the target junction temperature is obtained, the optical radiation of the LED during a current pulse. The method may further comprise measuring the Tⱼ of the LED; calculating a target V_{f} based on a predetermined relationship of the change of V_{f} to the change of Tⱼ. The method may be performed repeatedly for each of a plurality of LEDs.

In another embodiment, an LED test apparatus is provided. The apparatus comprises a stage configured to hold one or more LED for testing. The apparatus also comprises a signal generator for providing a power signal to an LED in the stage. The signal generator is configured to provide a PWM signal wherein the signal generator can adjust a duty factor, a pulse width, an amplitude, and/or a frequency of the PWM signal such that the LED operates at a target Tⱼ. A photospectrometer is provided for measuring an optical radiation of the LED in the stage. In some embodiments, the LED test apparatus further comprises an integrating sphere having a test port, and wherein the stage is configured such that an LED in the stage provides optical radiation into the integrating sphere by way of the test port. In some embodiments, one or more LED calibration standards are affixed to the stage of an LED test apparatus.

In another embodiment, a method for calibrating an LED test apparatus is provided. The method comprising providing a PWM signal to an LED calibration standard. The PWM signal has current pulses with a duty factor, a pulse width, an amplitude, and a frequency.

One or more of the duty factor, the pulse width, the amplitude, and/or the frequency of the current pulses are adjusted to provide a V_{f}, which corresponds with a target Tⱼ of the LED calibration standard. When the target junction temperature is obtained, the optical radiation of the LED calibration standard is measured during a current pulse. Optical measurement offset value(s) for the LED test apparatus are calculated according to the measured optical radiation of the LED calibration standard.

In another embodiment of the present disclosure, a method for heating an LED to a target Tⱼ is provided. PWM signal is provided to the LED. The PWM signal has current pulses with a duty factor, a pulse width, an amplitude, and a frequency. The method comprises adjusting the duty factor, the pulse width, the amplitude, and/or the frequency of the current pulses to provide a V_{f} which corresponds with the target Tⱼ of the LED.

In another embodiment, an LED test apparatus is provided. The Apparatus has a stage configured to hold one or more LED for testing. At least one LED calibration standard is affixed to the stage. The apparatus has a signal generator for providing a power signal to an LED in the stage. The signal generator is configured to adjust a duty factor, a pulse width, an amplitude, and/or a frequency of the power signal such that the LED operates at a target Tⱼ. The apparatus has a photospectrometer for measuring an optical radiation of the LED, when a LED is in the stage, or the LED calibration standard affixed to the stage.

### DESCRIPTION OF THE DRAWINGS

For a fuller understanding of the nature and objects of the disclosure, reference should be made to the following detailed description taken in conjunction with the accompanying drawings, in which:

FIG. 1 is a prior art LED calibration standard;

FIG. 2 is a graph showing the junction temperature of an LED in an LED calibration standard over time;

FIG. 3 is an example of a PWM signal adjusted in accordance with an embodiment of the present disclosure;

FIG. 4 is a graph showing an LED measurement wherein the LED is suspended in air without a heat sink, and the LED was heated using a junction pre current of 250 mA to 85° C. by varying the pulse widths of the PWM drive signal;

FIG. 5 is a graph showing the measured flux, in lumen, of the LED of FIG. 4 over the same time period;

FIG. 6 is a graph showing the value of the chromaticity coordinate x for the LED of

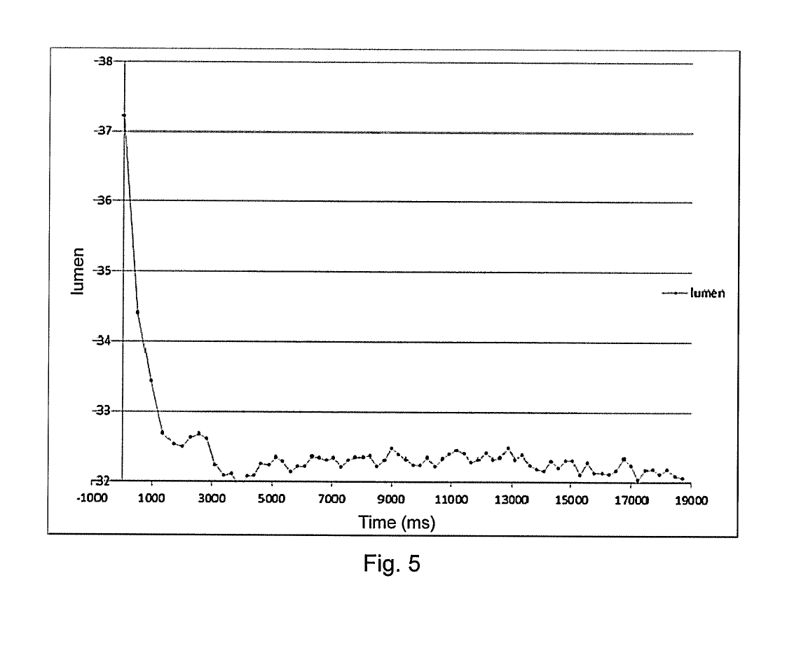

FIGS. 4 and 5 over the same time period;

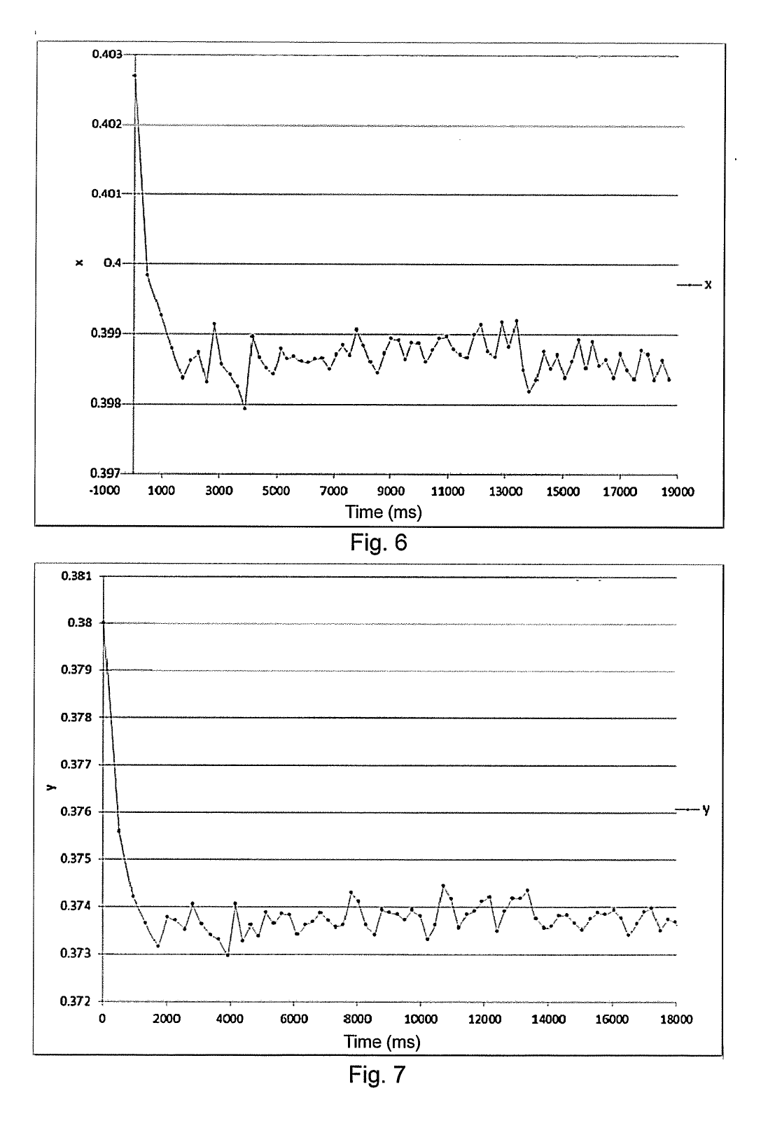

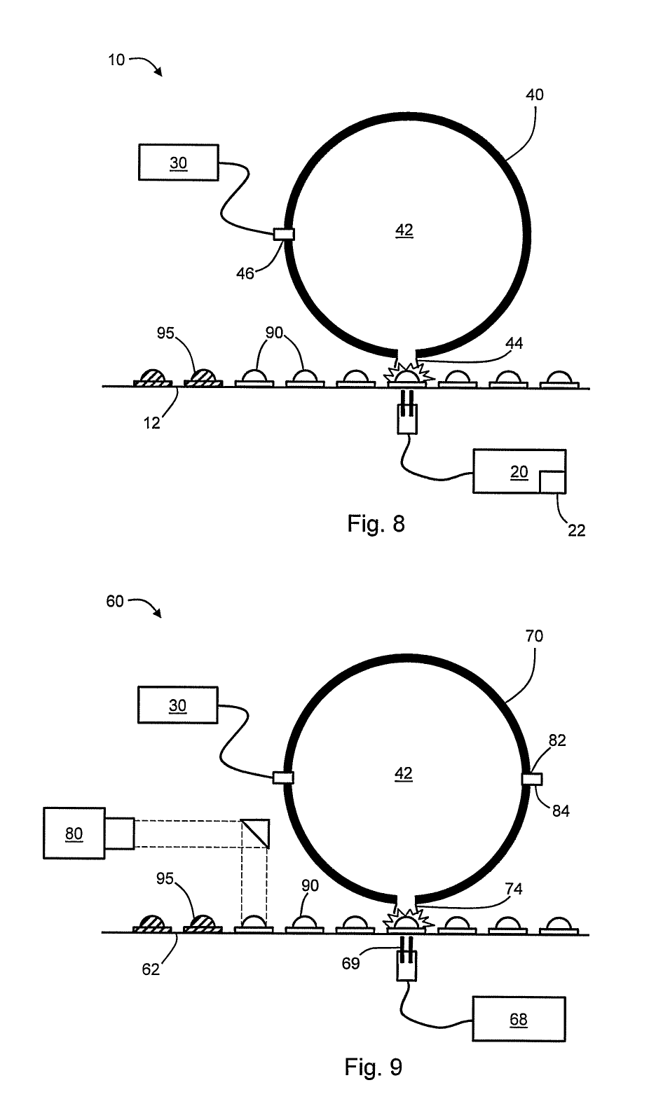

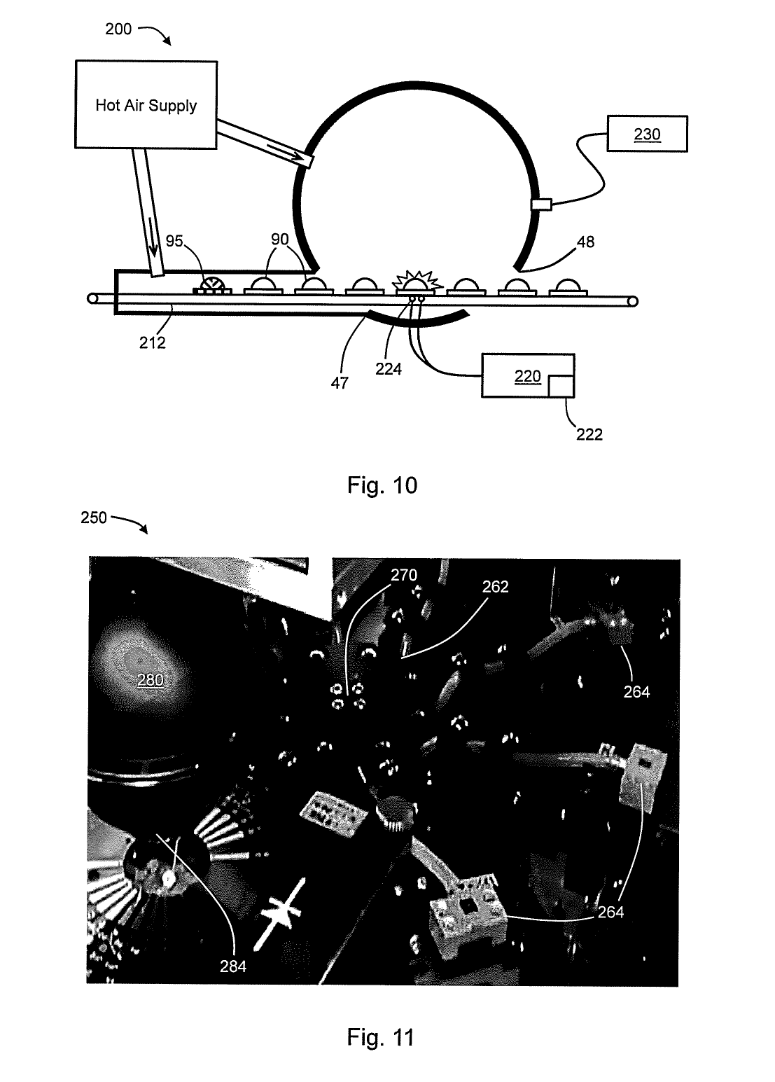

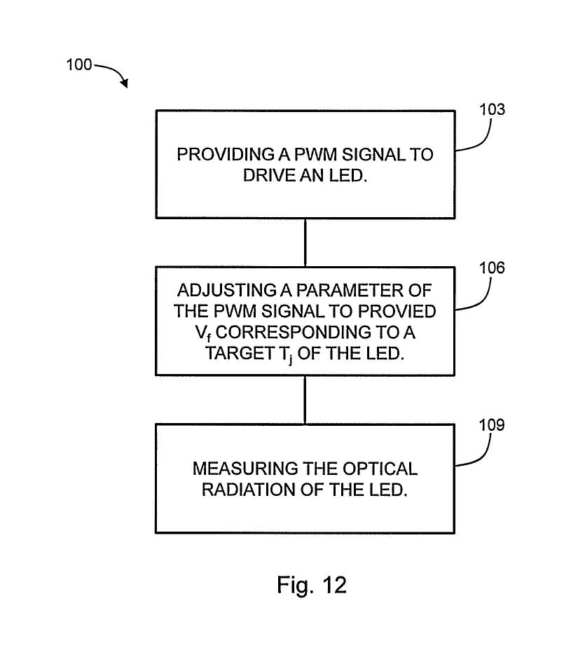

FIG. 7 is a graph showing the value of the chromaticity coordinate y for the LED of FIGS. 4, 5, and 6 over the same time period;

FIG. 8 is depicts a test apparatus according to an embodiment of the present disclosure;

FIG. 9 depicts an LED tester apparatus according to another embodiment of the present disclosure, wherein the stage of the tester is an x-y stage;

FIG. 10 depicts an apparatus according to another embodiment of the present disclosure wherein the stage is a conveyor belt;

FIG. 11 shows an apparatus according to an embodiment of the present disclosure wherein the stage is a rotating turret; and

FIG. 12 shows a flowchart according to another embodiment of the present disclosure.

### DETAILED DESCRIPTION OF THE DISCLOSURE

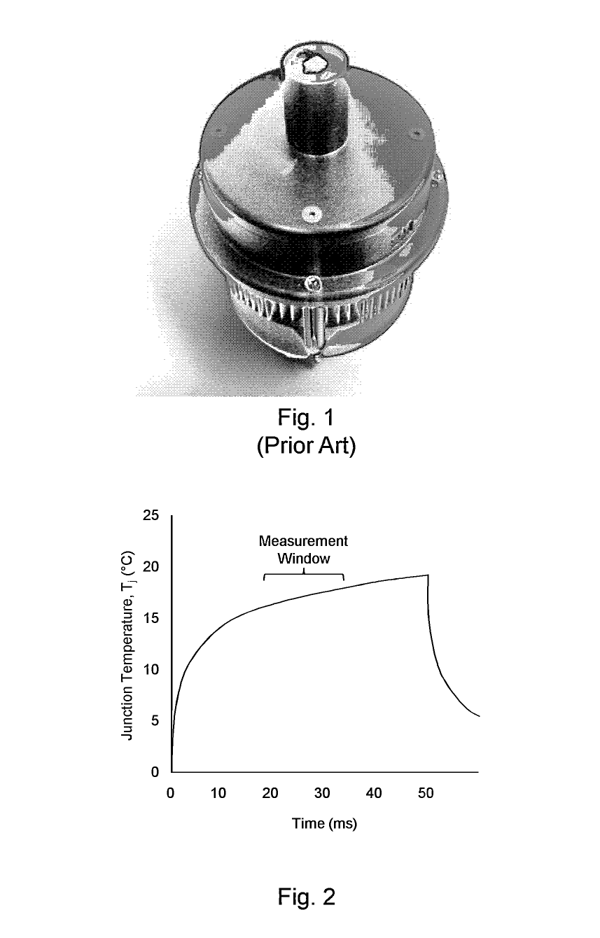

In one aspect, the present disclosure can be embodied as a method 100 for measuring optical radiation from a light-emitting diode (LED) calibration standard. In order to provide thermal regulation of the LED calibration standard, a pulse-width modulated (PWM) signal is provided 103 to drive the LED calibration standard. As is known in the art, a PWM signal is made up of a plurality of current pulses (typically square wave pulses of high and low values, but may have other waveforms). It should be noted that the term PWM is used for convenience throughout the application to refer to a signal comprising a plurality of pulses, and should not be interpreted as limiting the disclosure only to embodiments where the pulse width of the signal is modulated. As will be apparent in light of the present disclosure, in some embodiments, other characteristics of the signal are modulated while the pulse width is constant. Characteristics of the current pulses can be varied. For example, the pulse width of a current pulse can be made longer or shorter in duration, such as in FIG. 1, where pulse P1 is shown having a duration of 300 ms and pulse P2 is shown having a duration of 250 ms. Another way to vary a PWM signal is by changing the duty cycle, which is the proportion of high signal time to the total period of a high/low pulse. Yet another way in which a PWM signal may be varied is by changing the frequency of the pulses of the PWM signal (sometimes referred to as the “switching frequency”). The amplitude of pulses of the PWM signal may also be varied.

According to embodiments of the present disclosure, the junction temperature, Tⱼ, of an LED driven by a PWM signal can be controlled by varying the characteristics of the PWM signal. While LED current pulses have been used for determining Tⱼ, the present disclosure allows for active heating of the LED to bring Tⱼ to target. The PWM signal may be adjusted, for example, to provide a forward voltage across the junction of the diode, V_{f}, which corresponds with a target junction temperature, Tⱼ, of the LED. This is found to be useful for self-heating (i.e., intrinsic heating) of the diode junction in an LED calibration standard—thereby reducing or eliminating the need for external heaters in such standards. Furthermore, the size of the heat sink can be reduced or eliminated, possibly using only the LED substrate or a printed circuit board (PCB) on which the LED is mounted as the heat sink. Without an external heater and heat sink, an LED calibration standard can be significantly reduced in size and, in some cases, may be the same size as an LED device-under-test. This allows for in-situ calibration standards on production equipment as further described below. Such fast control and stabilization of the junction temperature of LEDs may also allow for higher throughput testing of production LEDs.

As such, the method 100 includes the step of adjusting 106 the duty factor, the pulse width, amplitude, and/or the frequency of the PWM signal pulses to provide a V_{f} corresponding to a desired Tⱼ of the LED calibration standard. The target Tⱼ is often the designed real-world operating Tⱼ of the LED and is higher than the test ambient temperature (or the heat sink temperature). A typical value for target Tⱼ (depending on the type of the LED) is between 40° C. and 85° C., but higher and lower target junction temperatures are possible. The target Tⱼ may be a range around a target temperature. For example, a target Tⱼ may have a tolerance off 1%, 2%, 3%, 5%, 10%, or other values around the temperature. As Tⱼ approaches its target value, the properties (pulse width, duty factor, frequency, and amplitude) of the current pulses may be further adjusted 106 to minimize the time required for Tⱼ to settle at its target value (as shown in the figure above, for example). In some embodiments, a feedback loop can be used to adjust the pulse properties according to the Tⱼ.

When the target Tⱼ is obtained (e.g., Tⱼ has settled within its tolerance from the target Tⱼ), the optical radiation of the LED calibration standard is measured 109. The optical radiation measurement 109 may include, for example, spectral flux, luminous flux, radiant flux, color coordinates, correlated color temperature, etc. A typical optical radiation measurement takes 2˜20 ms to complete. In some embodiments, it is preferred to make this measurement 109 after the initial steep rise of Tⱼ. For example, in the graph of FIG. 2, showing a 50 ms current pulse, the measurement 109 is made around 20˜30 ms from the beginning of the pulse. In some embodiments, the start time of the optical radiation measurement 109 within the current pulse can be set dynamically at a specific target Tⱼ (for example, using V_{f} to determine Tⱼ). In other embodiments, the measurement 109 may also be set to start when Tⱼ is slightly below the target value. In this way, the average value of Tⱼ during the entire optical radiation measurement time is equal to its target value.

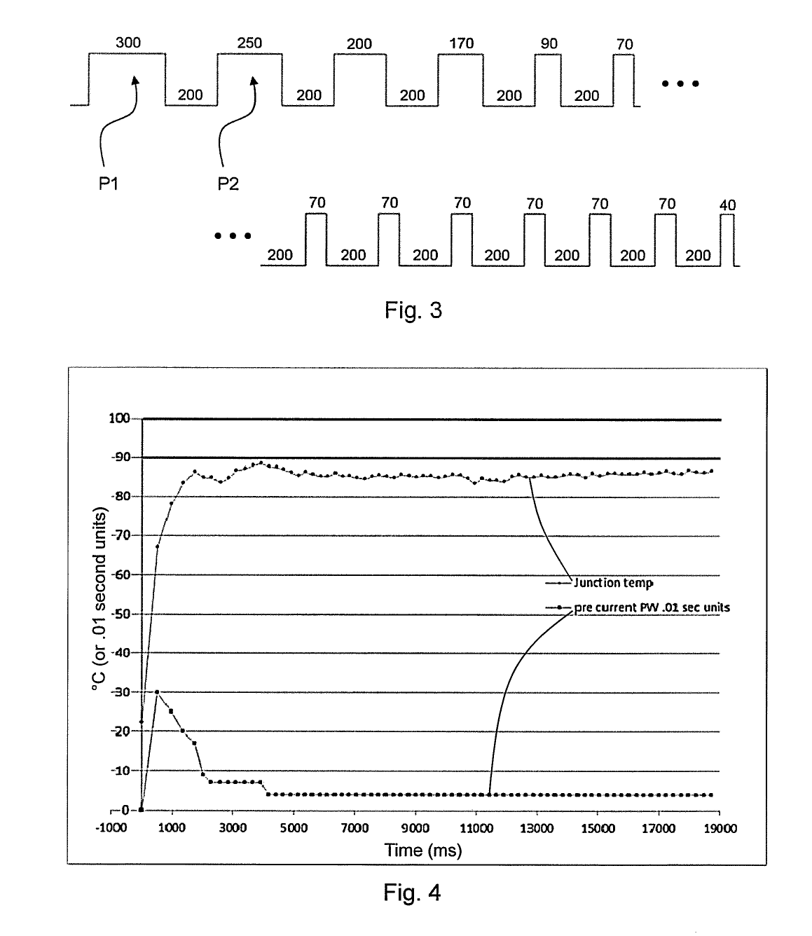

A measurement using an exemplary method according to an embodiment of the present disclosure was made. The PWM signal over the first 5000 ms is shown in FIG. 3. FIG. 4 is a graph showing the junction temperature (top line) over time (where the PWM signal of FIG. 3 is matched to the graphed time from 0 to 5000 ms). It is apparent from the graph that the junction temperature can be brought to a target temperature (in this case 85° C.) quickly and accurately, and subsequently maintained at the target Tⱼ. FIGS. 5, 6, and 7 show, respectively, the flux (in lumen) and chromaticity coordinates (x, y) of the LED over the same period as FIG. 4.

In embodiments of the present disclosure, the amplitude of the current pulse during which the optical radiation measurement is made, or when calculating the target V_{f}, must be the same as the value for which the V_{f} vs. Tⱼ function was established. At other times, the current pulses can have a different amplitude (from near zero to more than the measurement current) and/or a different duty factor (from near zero to 100%, i.e., CW) in order to reach and maintain the target Tⱼ effectively, as long as the drive signal is within the safe parameters for the LED.

In some embodiments, one or more pulse parameters may be held constant while varying other parameters to obtain a V_{f} for a desired Tⱼ. For example, in some embodiments of the method 100, repetitive current pulses can be run with specified amplitude through the LED. The properties of repetitive pulses (mainly the duty factor, but may also include absolute pulse width, and frequency) can be adjusted to obtain a specific forward voltage V_{f} corresponding to a desired Tⱼ for the specified amplitude of current.

The mechanism for controlling Tⱼ is the balance between heating by such adjustable LED current pulses and heat dissipation into ambient air and/or the minimized heat sink. Tⱼ can be driven to the desired value and maintained at such value by adjusting the LED current pulses (e.g., pulse width, duty factor, amplitude, and frequency) to obtain a desired V_{f}. This adjustment can be made using a static algorithm or in real-time using an adaptive algorithm. In an example of a static algorithm, a target V_{f} can be set based on prior knowledge of the absolute V_{f} vs. Tⱼ function for a given current for each type of LED, or for a specific individual LED.

In an example of a real-time adjustment, the target V_{f} can be set by first measuring actual Tⱼ (equal to the LED substrate or heat sink temperature which can be obtained using a separate temperature sensor, for example, a calibrated thermocouple, prior to turning on the LED) and V_{f} at the beginning of the first pulse. The target V_{f} may then be calculated based on a known “change of V_{f}” vs. “change of Tᵢ” function in real-time for of an LED. Such real- time approaches are usually more accurate than static algorithms. Other techniquest for determining target V_{f} (i.e., V_{f} corresponding to a target Tⱼ) can be used.

The accuracy of the presently disclosed pulsed LED standard is comparable to that of its CW counterpart, because it is determined by the accuracy of LED current and Tⱼ at the moment of measurement, which is obtained through precision timing for pulsed standards. In addition, because Tⱼ can be controlled adaptively, a single hardware design and algorithm can accommodate a wide range of LED types, testing tools, and operation conditions. No separate heating mechanism (other than self-heating as disclosed herein), e.g., from heat sink, hot air, or any radiation heating, is required, although such mechanisms can be used in combination the presently disclosed technique. While prior heating techniques using external mechanisms require times on the order of minutes to tens of minutes for heating, the presently disclosed method is advantageous and the target Tⱼ may be reached as fast as a few seconds or less. The faster heating capability enables faster and more frequent calibrations. In some cases, the heating time may be fast enough for production testing of LED's at their real-world operating temperatures. Ambient or heat sink temperature (or other environmental conditions) would generally not affect the final Tⱼ or the optical radiation measurement results, because Tⱼ is adjusted in real-time to an absolute target value above and independent of ambient temperature.

During the self-heating phase (with current pulses) before optical radiation measurement, in order to reduce the time required to reach target Tⱼ, the amplitude of the pulses may be different from that to be used for calculating target V_{f} and for optical radiation measurement. The waveform of the current pulses in during this time may be different from square-wave, for example, the waveform may be triangular, having smooth tops and bottoms, or modulated by <100% (never reaching zero), to reduce noise and errors caused by high harmonics. Such pulses may also be interspersed with regular measurement pulses such as described above. This method of heating may be used alone, or in combination with other heating methods, for example, hot air, radiation, or resistive heating, which may result in more accurate temperature control and/or faster settling.

In another aspect of the present disclosure, an LED test apparatus 10 is provided. The apparatus 10 may be used, for example, to test the function of LEDs during the manufacturing process. The apparatus 10 comprises a stage 12, where an LED device-under-test (DUT) 90 is located during testing. The stage 12 may be a platform, a conveyor belt, a rotating turret, or any other device suitable for positioning the DUT 90 in the apparatus 10. In some embodiments, such as where the stage 12 is a conveyor belt, the apparatus 10 may be configured such that the DUT 90 is in continuous motion during the test.

The stage 12 is further configured receive an in-situ LED calibration standard 95 in place of a DUT 90. In some embodiments, the in-situ calibration standard has a form factor that is the same as a DUT. In other embodiments, the form factor of the standard need not be the same, but is compatible with the DUT such that the apparatus 10, including the stage 12 does not require reconfiguration in order to process the standard.

The apparatus 10 comprises a signal generator 20 for providing a power signal to a device-under-test 90 or a calibration standard 95 in the stage 12. In this way, the DUT 90 or calibration standard 95 can be energized for measurement of the optical radiation. The signal generator 20 is configured to provide a PWM signal for heating the calibration standard 95 before measurement. For example, the signal generator 20 may include a controller 22 which is programmed to perform any of the methods described above for heating an LED to a target Tⱼ. In a particular embodiment, the controller 22 is programmed to cause the signal generator to provide a PWM signal to the calibration standard 95 and to adjust parameters of the PWM signal pulses (duty factor, pulse width, amplitude, frequency, etc.) to obtain a target Tⱼ of the LED calibration standard 95. The signal generator 20 may be configured to provide a PWM signal to a DUT 90 to heat the DUT 90 to a desired Tⱼ. In this way, the DUT 90 can be tested at a selected operating temperature.

The controller 22 may further be programmed to determine a Tⱼ based on the V_{f} provided by the signal generator 20. As such, the controller 22 may be further programmed to provide closed-loop control of the Tⱼ.

Although described as a controller, it is to be appreciated that the controller 22 may be implemented in practice by any combination of hardware, software, and firmware. Also, its functions as described herein may be performed by one unit, or divided up among different components, each of which may be implemented in turn by any combination of hardware, software and firmware. Program code or instructions for the controller 22 to implement the various methods and functions described herein may be stored in processor readable storage media, such as memory.

The apparatus 10 further comprises a photospectrometer 30 for measuring an optical radiation of a device in the stage 12. The optical radiation measurement may include, for example, spectral flux, luminous flux, radiant flux, color coordinates, correlated color temperature, etc. In some embodiments, the stage 12 is moveable such that a DUT 90 or an LED calibration standard 95 can be moved into a testing position for measurement by a spectrometer.

The photospectrometer 30 may be in coordination with the signal generator 20 such that the optical radiation measurement is performed after the device being measured (whether a DUT 90 or a calibration standard 95) has been brought up to a desired Tⱼ. For example, in some embodiments, the photospectrometer 30 is in communication with controller 22 and may receive a measurement actuation signal from the controller 22. In this way, when the device settles within the tolerance range of the target Tⱼ, the controller 22 provides a signal to the spectrometer 30 at the start of the next PWM pulse such that the spectrometer may measure the device at a time during such pulse. Other configurations and timings may be used. For example, spectrometer 30 may be signaled by a controller that is not controller 22, or the spectrometer 30 may provide a signal to other components, etc. A typical optical radiation measurement takes 2˜20 ms to complete. In some embodiments, the spectrometer 30 may be configured to measure the optical radiation of a device after an initial steep rise of Tⱼ during a PWM measurement pulse. In some embodiments, the start time of the optical radiation measurement within the current pulse can be set dynamically at a specific target Tⱼ (for example, using V_{f} to determine Tⱼ). In other embodiments, the measurement may also be set to start when Tⱼ is slightly below the target value. In this way, the average value of Tⱼ during the entire optical radiation measurement time is equal to its target value.

The LED test apparatus 10 may include an integrating sphere 40. Such integrating spheres are known for use in optical measurements. When an integrating sphere 40 is used, the stage 12 is configured such that a device in the stage 12 provides its optical radiation into a hollow cavity 42 of the integrating sphere 40. For example, the stage 12 may position the device at an test port 44 of the integrating sphere 40. As such, the optical radiation is scattered in a diffuse way and may be measured by the photospectrometer 30 which is configured in a measurement port 46 of the integrating sphere 40. In another embodiment, where the stage 12 is a conveyor belt, the integrating sphere 40 may have an inlet port 47 and an outlet port 48 such that the conveyor belt may transport a device through the cavity 42 of the integrating sphere 40.

Apparatus of the present disclosure advantageously provides that LED calibration standards are presented to the spectrometer (for example, by way of the integrating sphere) in the same way as the devices-under-test. In this way, geometric calibration offsets can be reduced or eliminated. In this regard, it may be advantageous, in some embodiments, to configure the integrating sphere to collect 100% of the light from both the calibration source 95 as well as the DUTs 90. Transfer standards can be made from product LEDs (i.e., can be made from the same LEDs as the devices-under-test), which allows for calibrating that is specific to each model of LED product. This would significantly reduce measurement errors caused by using a “generic” calibration standard for different products with different optical properties (particularly spectrum, beam profile, light output, and self-absorption of light).

Embodiments of the present disclosure may use calibration sources which are relatively broadband so as to cover the full range of wavelengths emitted by various LED DUTs. Alternatively, multiple calibration sources could be provided, each optimized to match various LED DUTs based on lumen output, drive current, angular light distribution (beam profile), spectrum (or CCT), etc. In some embodiments having multiple in-situ transfer standards 95, a first standard may be calibrated off the apparatus in order to establish absolute calibration and traceability (this is not expected to be done frequently and can become a maintenance step). The other in-situ standards of such an apparatus can then be calibrated to the first standard.

In some embodiments, the stage 12 is configured such that the LED calibration standards 95 (i.e., the in-situ transfer standards) are removable from the stage, allowing them to be calibrated or recalibrated on a separate measurement system. For example, the standards may be calibrated using a laboratory tester calibrated to NIST, to establish and maintain traceability and accuracy. Similarly, the stage 12 may be configured such that the LED calibration source module may be exchanged with a different calibration source, allowing for the use of a calibration source which is the same as (or similar to) the device-under-test.

In some embodiments, such as the exemplary embodiment of a tester 60 of FIG. 9, the stage 62 may be configured to hold multiple in-situ standards. For example, in the depicted exemplary embodiment, stage 62 is an x-y stage configured to translate such that a desired standard 95 held on the stage 62 may be selected for use in the apparatus 60 at any given time. In embodiments having a stage with multiple in-situ standards, calibration standards can be provided to cover the entire wavelength range of interest without requiring manual intervention to change standards.

An apparatus 60 may further comprise an alignment camera 80 for proper positioning of a device within the test port 74 of the integrating sphere 70. The alignment camera 80 may be positioned to align the stage 62 based on a marker 63 on the stage 62, which is away from the DUT 90. In other embodiments, the alignment camera is positioned to align the stage 62 based on the alignment of the DUT 90 in the test port 74. In the apparatus 60 depicted in FIG. 9, the signal generator 68 is electrically connected to the DUT 90 by way of “pogo pins” 69. Other electrical connectors are known and may be used with versions of the presently disclosed apparatus.

The integrating sphere may also have a calibration port in which a traditional LED calibration standard can be placed. For example, the apparatus 60 of FIG. 9 includes a calibration port 82 in which calibration standard 84 is located.

FIG. 10 depicts an embodiment wherein the apparatus 200 has a stage 212 configured as a conveyor belt. In this embodiments, four rotating electrical contact pins, two for driving current and two for voltage measurement, are provided in order to reduce a voltage measurement error caused by a voltage drop at the current pin contact points and current carrying wires. FIG. 11 shows an embodiment of an apparatus 250 wherein the stage 262 is a rotating turret which rotates about an axis 270 such that each of a plurality of LED chip holders 264 can be moved into position at the test port 284 of the integrating sphere 280. The in-situ standard may be made with an array of LED's (a “COB” or “chip on board”). Heaters may be integrated into the stage, the LED holders on turret arms, the integrating sphere, or otherwise, for calibration or testing at an elevated and controlled temperature.

In some embodiments, apparatus of the present disclosure will not include an LED device-under-test or a calibration standard until the apparatus is placed into service. However, in other embodiments, one or more LEDs and/or one or more LED calibration standards may make up a part of the apparatus. For example, in some embodiments, an apparatus comprises a stage having an LED calibration standard affixed thereto.

Although the present disclosure has been described with respect to one or more particular embodiments, it will be understood that other embodiments of the present disclosure may be made without departing from the spirit and scope of the present disclosure. Hence, the present disclosure is deemed limited only by the appended claims and the reasonable interpretation thereof.

1. A method for measuring optical radiation from a light-emitting diode (LED), comprising:
providing a pulse-width modulated (PWM) signal to the LED, the PWM signal having current pulses with a duty factor, a pulse width, an amplitude, and a frequency;
adjusting the duty factor, the pulse width, the amplitude, and/or the frequency of the current pulses to provide a forward voltage, V_{f}, which corresponds with a target junction temperature, Tⱼ, of the LED; and
measuring, when the target junction temperature is obtained, the optical radiation of the LED during a current pulse.

2. The method of claim 1, further comprising:
measuring the Tⱼ of the LED; and
calculating a target V_{f} based on a predetermined relationship of the change of V_{f} to the change of Tⱼ.

3. The method of claim 2, wherein the Tⱼ of the LED is measured using a thermocouple.

4. The method of claim 1, wherein the V_{f} corresponding to the target Tⱼ is predetermined.

5. The method of claim 1, wherein the provided PWM signal has a triangular waveform before the LED has obtained the target Tⱼ.

6. The method of claim 1, wherein the provided PWM signal has a square pulse when the LED is measured.

7. An LED test apparatus, comprising:
a stage configured to hold one or more LED for testing;
a signal generator for providing a power signal to an LED in the stage, and wherein the signal generator is configured to provide a PWM signal wherein the signal generator can adjust a duty factor, a pulse width, an amplitude, and/or a frequency of the PWM signal such that the LED operates at a target junction temperature, Tⱼ; and
a photospectrometer for measuring an optical radiation of the LED in the stage.

8. The LED test apparatus of claim 7, further comprising an integrating sphere having a test port, and wherein the stage is configured such that an LED in the stage provides optical radiation into the integrating sphere by way of the test port.

9. The LED test apparatus of claim 8, further comprising an alignment camera configured to align the stage to the test port of the integrating sphere.

10. The LED test apparatus of claim 8, wherein the stage is a conveyor belt, and the integrating sphere is configured such that the conveyor belt passes through an inlet port and an outlet port of the integrating sphere.

11. The LED test apparatus of claim 7, wherein the stage is an x-y stage.

12. The LED test apparatus of claim 7, wherein the stage is a rotating turret.

13. The LED test apparatus of claim 7, wherein the signal generator is configured to provide a square waveform.

14. The LED test apparatus of claim 7, further comprising one or more LED calibration standards affixed to the stage.

15. The LED test apparatus of claim 7, further comprising a heater for configured to provide heat to devices on the stage.

16. A method for calibrating an LED test apparatus, comprising:
providing a pulse-width modulated (PWM) signal to an LED calibration standard, the PWM signal having current pulses with a duty factor, a pulse width, an amplitude, and a frequency;
adjusting the duty factor, the pulse width, the amplitude, and/or the frequency of the current pulses to provide a forward voltage, V_{f}, which corresponds with a target junction temperature, Tⱼ, of the LED calibration standard;
measuring, when the target junction temperature is obtained, the optical radiation of the LED calibration standard during a current pulse; and
calculating optical measurement offset values for the LED test apparatus according to the measured optical radiation of the LED calibration standard.

17. An LED driver comprising a PWM signal generator for providing a plurality of current pulses to an LED and configured to vary a duty factor, a pulse width, amplitude, and/or a frequency of the current pulses such that the LED operates at a target Tⱼ.

18. A method for heating a light-emitting diode (LED) to a target junction temperature, Tⱼ, comprising:
providing a pulse-width modulated (PWM) signal to the LED, the PWM signal having current pulses with a duty factor, a pulse width, an amplitude, and a frequency; and
adjusting the duty factor, the pulse width, the amplitude, and/or the frequency of the current pulses to provide a forward voltage, V_{f}, which corresponds with the target Tⱼ of the LED.

19. The method of claim 18, wherein the provided PWM signal has a square waveform.

20. An LED test apparatus, comprising:
a stage configured to hold one or more LED for testing;
an LED calibration standard affixed to the stage;
a signal generator for providing a power signal to an LED in the stage; and
a photospectrometer for measuring an optical radiation of the LED in the stage or the LED calibration standard affixed to the stage.

21. The LED test apparatus of claim 20, further comprising one or more additional LED calibration standards affixed to the stage.

22. The LED test apparatus of claim 20, further comprising an integrating sphere having a test port, and wherein the stage is configured such that an LED in the stage or the LED calibration standard attached to the stage provides optical radiation into the integrating sphere by way of the test port.

23. The LED test apparatus of claim 20, wherein the signal generator is configured to provide a PWM signal wherein the signal generator can adjust a duty factor, a pulse width, an amplitude, and/or a frequency of the PWM signal such that the LED operates at a target junction temperature, Tⱼ
